(19) United States
(12) Patent Application Publication
(10) Pub. No.: US 2004/0203577 A1
(43) Pub. Date: Oct. 14, 2004

(54) Remotely monitoring and controlling automobile anti-theft sound alarms through wireless cellular telecommunications

(75) Inventors: Ira R. Forman, Austin, TX (US); Nadeem Malik, Austin, TX (US); Marques Benjamin Quiller, Pflugerville, TX (US)

Correspondence Address: International Business Machines Corporation, Intellectual Property Law Department, Internal Zip 4054, 11400 Burnet Road, Austin, TX, 78758, US

(73) Assignee: International Business Machines Corporation, Armonk, NY

(21) Appl. No.: 10/205,673

(22) Filed: Jul. 25, 2002

(51) Int. Cl. H04M 11/00

(52) U.S. Cl. 455/404.2; 455/420

(57) ABSTRACT

A cellular telecommunications system to notify the automobile user of the triggering of his automobile alarm is a relatively inexpensive manner that enables the user to make a timely response to the condition. A wireless telephonic device in an automobile that is responsive to the triggering of the alarm audio output for sending a cellular telephonic message over the cellular network indicating the triggering of said output to a designated receiving telephone. The automobile also includes a device enabling a user to selectively designate the receiving telephone to which said telephonic message is to be sent. The receiving telephone is also likely to be a mobile wireless cellular telephone.

The wireless telephonic device in said automobile is adapted to receive cellular telephonic signals from the designated cellular telephone, i.e. the wireless device is a transceiver. In addition, there may be a device for sensing ambient conditions in the automobile (during the alarm period) and the wireless telephonic device (transceiver) may transmit cellular telephonic signals indicative of said sensed ambient conditions to said designated cellular telephone. The device for sensing the ambient conditions in the automobile may be a video camera or an audio sensor. The sensed video or audio during the alarm period may be transmitted as cellular telephonic signals indicative of these sensed ambient conditions to said designated cellular telephone so that the automobile user may take appropriate action with respect to the alarm.

### TECHNICAL FIELD

The present invention relates to telecommunications through mobile wireless cellular telephone systems, and particularly to the use of such systems to monitor and control automobile anti-theft sound alarms.

### BACKGROUND OF RELATED ART

With the globalization of business, industry and trade wherein transactions and activities within these fields have been changing from localized organizations to diverse transactions over the face of the world, the telecommunication industries have, accordingly, been expanding rapidly. Wireless telephones and, particularly, cellular telephones have become so pervasive that their world wide number is in the order of hundreds of millions. While the embodiment to be subsequently described relates to cellular telephones, the principles of the invention would be applicable to any wireless personal communication device that could be used to communicate in a cellular telecommunications system. These would include the wide variety of currently available communicating personal palm devices or Personal Digital Assistants (PDAs), which include, for example, Microsoft's WinCE line; the PalmPilot line produced by 3Com Corp.; and International Business Machines Corporation's WorkPad. These devices are comprehensively described in the text, Palm III & PalmPilot, Jeff Carlson, Peachpit Press, 1998.

Despite the rapid expansion of and the proliferation of wireless cellular telephones and networks, the industry is experiencing a decrease in consumer demand for wireless cellular telecommunications products. As a result, the industry is seeking new and expanded uses for its products. The present invention offers such an expanded application for wireless cellular telephone technology in the automobile alarm market. Like the cellular telephone industry, the automobile alarm industry has also been expanding rapidly due to the great increase in costs to replace automobiles. The proliferation of alarms installed in automobiles has reached the point that a very high percentage of automobiles have sound alarm systems. Because of the aging of alarm equipment in some automobiles, as well as increased sensitivity of newer automobile alarm systems, the triggering of false alarms in autos has reached almost epidemic proportions. The annoyance to the public at home, on the street or at work is widespread and pronounced. The incidence of false auto alarms has reached the point that the triggering of automobile alarms is often ignored not only by the public, but at times, by law enforcement personnel as well. In fact, the nuisance of false auto alarms has become so extensive that, in some jurisdictions, there are ordinances requiring automobile alarms to turn off at a set time after triggering. This public indifference to the nuisance of alarms has thwarted the very propose of automobile alarms as anti-theft devices.

There has been some technology proposed and developed to alert the automobile user of the triggering of his automobile alarm so as to permit him to either implement an early response in an actual theft or to shut down a false alarm. Global tracking systems via satellites, Global Positioning Satellites (GPS), offer some form of response to theft situations including, at least, indirect notification to the user. However, such systems are relatively costly. Also, the remote control radio frequency (RF) devices in the form of key fobs with which users lock/unlock doors and turn alarms on-off may have some sort of alarm-triggered warning function, but these operate over short line-of-sight distances.

### SUMMARY OF THE PRESENT INVENTION

The present invention provides a solution to the problem of effective response to triggered automobile alarms that uses the cellular telecommunications system to notify the automobile user of the triggering of his automobile alarm in a relatively inexpensive manner to thereby enable the user to make a timely response to the condition. The invention includes a wireless telephonic device in the automobile that is responsive to the triggering of the alarm audio output for sending a cellular telephonic message over the cellular network indicating the triggering of the alarm to a designated receiving telephone. The automobile also includes a device enabling a user to selectively designate the receiving telephone to which the telephonic message is to be sent. The receiving telephone is also likely to be a mobile wireless cellular telephone, but the invention will also be operable with a standard wired telephone connected to the cellular network.

In accordance with a further aspect of the present invention, the wireless telephonic device in the automobile is adapted to receive cellular telephonic signals from the designated cellular telephone, i.e. the wireless device is a transceiver. In addition, there may be a device for sensing ambient conditions in the automobile (during the alarm period; and the wireless telephonic device (transceiver) includes means for transmitting cellular telephonic signals indicative of said sensed ambient conditions to said designated cellular telephone. The device for sensing the ambient conditions in the automobile may be a video camera or an audio sensor, e.g. microphone. The sensed video or audio during the alarm period may be transmitted as cellular telephonic signals indicative of these sensed ambient conditions to said designated cellular telephone so that the automobile user may take appropriate action with respect to the alarm. For example, there may be a device in the automobile for turning said audio alarm output off in response to a received telephonic signal from said designated telephone.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a block diagram of a generalized data processing system including a processor unit that provides the onboard automobile computer control for alarm monitoring and controlling system of the present invention;

FIG. 2 is a generalized diagrammatic view of a portion of a wireless mobile cellular telecommunications network including base station connected to a Public Switched Transmission Network (PSTN) showing the transmission paths to and from the cellular network in accordance with the invention;

FIG. 3 is an illustrative flowchart describing the setting up of the elements needed for the program of the invention for remotely monitoring and controlling automobile sound alarm anti-theft systems over a cellular telecommunications network; and

FIG. 4 is a flowchart of an illustrative simplified run of the program set up in FIG. 3.

### DETAILED DESCRIPTION OF THE PREFERRED EMBODIMENT

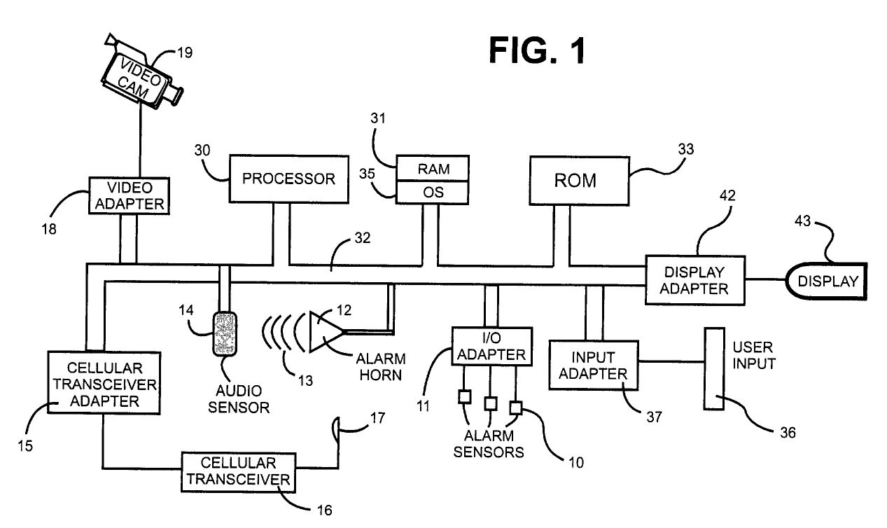

Referring to FIG. 1, there is provided a diagrammatic view of a typical computer control system that may function as an automobile onboard controller for various automotive functions, including the anti-theft audio alarm system, as well as the apparatus for monitoring and controlling it remotely through wireless cellular communications. The alarm system may be any conventional system with sensors 10 positioned throughout the automobile and connected via I/O adapter 11 to a central processing unit 30, which in turn is interconnected to various other components by system bus 32. An operating system 35 that runs on processor 30 provides control and is used to coordinate the functions of the various components of the control system. The OS 35 is stored in Random Access Memory (RAM) 31; which, in a typical automobile control system, has from four to eight megabytes of memory. The programs for the various automobile monitor and control functions including those of the present invention are permanently stored in Read Only Memory (ROM) 33, and moved into and out of RAM to perform their respective functions. The automobile has a basic display 43 controlled through display adapter 42 to provide information to the driver. Interactively responsive to the display information, the user provides commands to the automobile control system through a user input 36 that may conveniently be implemented by standard dashboard buttons connected via an appropriate input adapter 37. It is through this user input that the user may enter the I.D. or telephone number of the designated telephone. The user's cell phone may be the default telephone that the user may override with the telephone number at any location where he may be at any given time.

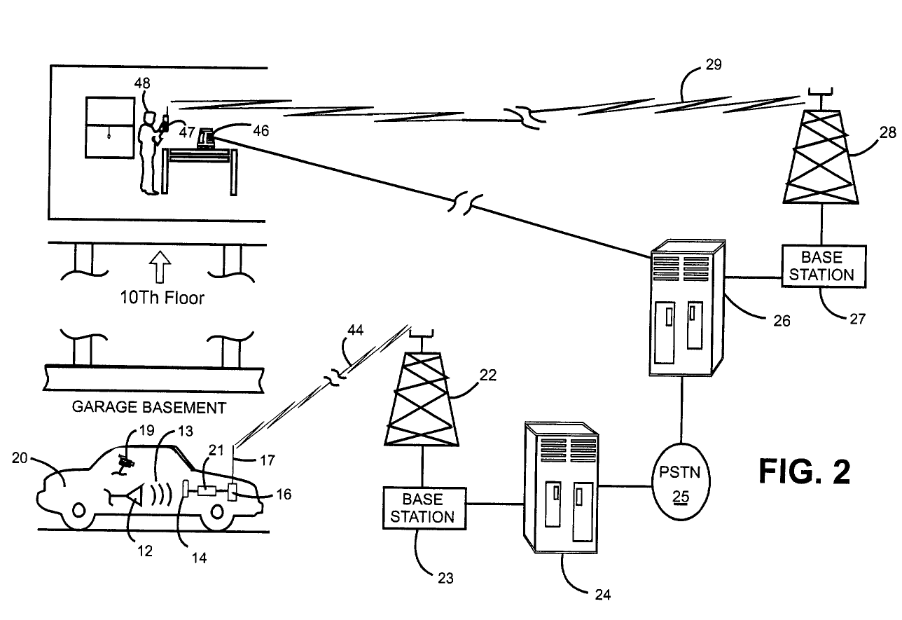

Accordingly, when any sensor 10 is tripped, the processor is notified and it sends a signal that sets off the alarm as represented by horn 12. Consider now the monitoring and control functions of the present invention. During the original setting up period, the user is prompted to enter a telephone number via a display user input 36; this telephone number is stored. When the alarm is triggered and emits its sound 13, the system will notify the user at his location remote from the automobile by calling the entered telephone number via a wireless cellular system. The triggering of the alarm may be detected directly within processor 30 or it may be detected by an audio sensor, such as microphone 14. The detection of such triggering results in a signal sent via cellular transceiver adapter 15 to cellular transceiver 16 mounted within the automobile. This results in a message being sent to the remote telephone receiver at the entered telephone number by wireless transceiver 16 with antenna 17 over a wireless cellular telephone system that will be described in greater detail with respect to FIG. 2. A transceiver is basically any conventional wireless cellular (transmitting/receiving) telephone mounted in the automobile under the control of processor 30 operating as will hereinafter be described. Video cam 19 connected via video adapter 18 may be any conventional micro-cam used for video surveillance. One or more of such video-cams may be dispersed within the automobile to provide the user with visual feedback as to automobile conditions should the user request such feedback after receiving the message of the triggering of the alarm. Likewise, microphone 14 represents one or more audio detectors that may be used for the same purpose. These will be discussed later with respect to FIG. 2.

In the example of FIG. 2, the user 48 has parked his automobile 20 in the basement garage of his office building and is now in his 10th floor office. He need not be in the same building; he may have taken a taxicab to another office in a remote section of town. In such a case, he should take his cell phone with him and have that cell phone number entered in his automobile. If the alarm is triggered, the onboard control system 21 (detailed in FIG. 2) detects this and cellular telephone transceiver 16 sends the alarm message via cellular signal 44 between antenna 17 and the nearest cellular tower 22.

At this point, some general background information on cellular telephone systems should be reviewed in order for the invention to be better understood.

In the cellular system for the handheld mobile wireless phone, an area such as a city is broken up into small area cells. Each cell is about 10 square miles in area. Each has its base station that has a tower for receiving/transmitting and a base connected into PSTN. Even though a typical carrier is allotted about 800 frequency channels, the creation of the cells permit extensive frequency reuse so that tens of thousands of people in the city can be using their cell phones simultaneously. Cell phone systems are now preferably digital with each cell having over 160 available channels for assignment to users. In a large city there may be hundreds of cells, each with its tower and base station. Because of the number of towers and users per carrier, each carrier has a Mobile Telephone Switching Office (MTSO) that controls all of the base stations in the city or region and controls all of the connections to the land based PSTN. When a client cell phone gets an incoming call, MTSO tries to locate what cell the client mobile phone is in. The MTSO then assigns a frequency pair for the call to the cell phone. The MTSO then communicates with the client over a control channel to tell the client or user what frequency channels to use. Once the user phone and its respective cell tower are connected, the call is on between the cell phone and tower via two-way long range RF communication. In the United States, cell phones are assigned frequencies in the 824-894 MHz ranges. Since transmissions between the cell telephone and cell tower are digital, but the speaker and microphone in the telephone are analog, the cell telephone has to have a D to A converter from the input to the phone speaker and an A to D converter from the microphone to the output to the cell tower.

Accordingly, with respect to FIG. 2, cellular transceiver 16 transmits and receives signals to and from towers 22 within the 824-894 MHz frequencies. Once appropriate contact is established with tower 22 the transmission would be conventional. The signals are passed through base station 23 to switching center 24 that then controls the routing of the call to a PSTN 30. The above-mentioned MTSO) is associated with the switching center 24. The PSTN then, in the conventional cellular manner, routes the call through switching center 26. If the telephone number designated receiving phone is wire based, as is phone 46, then the message is connected as shown. If the designated receiver is a wireless cellular phone 47, then the telephone message is routed through the cellular system to the base station 27 of the nearest tower 28 from which the wireless transmission 29 is sent. It should be noted that another tower 28 rather than the sending tower 22 is shown for illustration. This would be appropriate if the owner 48 were in another building a distance away from the garaged automobile. Actually, in the illustration shown where the user is in the same building, it is likely that the same neighborhood cell tower would be used for both stages of the wireless transmission.

The set up described could be used for simple alarm monitoring, e.g. the designated cellular phone 47 could be a pager showing a simple message such as “Alarm On” when the alarm is triggered. In such a case, the owner is likely to just go into the basement to check if the alarm is valid. On the other hand, the remote alarm monitoring and control could be more complex (e.g. in response to the alarm on message, the system could be set up to enable the user to send data back to the control system via cellular transceiver 16 to activate, via control processor 30, video 19 and/or audio sensors 14 to sense and transmit back to telephone 47). The user could then remotely analyze this data and determine whether the alarm is false. If the alarm were in error, the user could transmit back via cell phone 47 and transceiver 16, a signal to turn the alarm off.

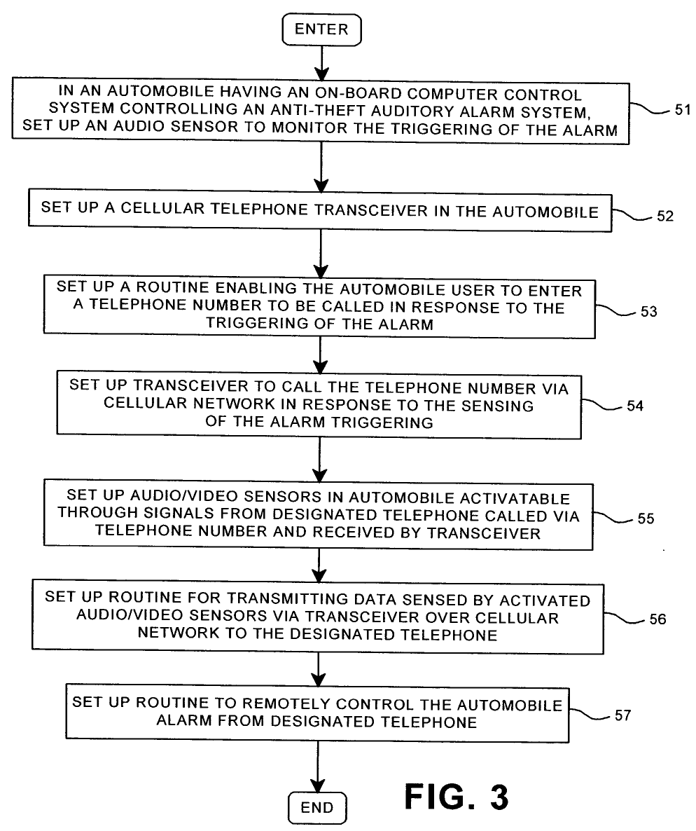

Now, with reference to the programming shown in FIG. 3, there will be described how the system and programs of the present invention are set up. In an automobile having a standard onboard computer system that, among other functions, controls an anti-theft sound alarm system, a sensor, either audio or triggered by data is set up to monitor the triggering of the alarm, step 51. A cellular telephone transceiver is set up in the automobile, step 52. A routine is set up enabling the automobile user to enter a telephone number to be called in response to the triggering of the alarm, step 53. Then the transceiver is set up to call the telephone via the cellular network in response to the sensing of the triggering of the alarm, step 54. Audio and video sensors are set up in the automobile activatable through signals from the designated telephone number transmitted back through the transceiver, step 55. A routine is set up for transmitting data sensed by activated audio or video sensors back again to the designated telephone via the transceiver, step 56. Finally, a routine is set up to remotely control the automobile alarm from the designated telephone, step 57.

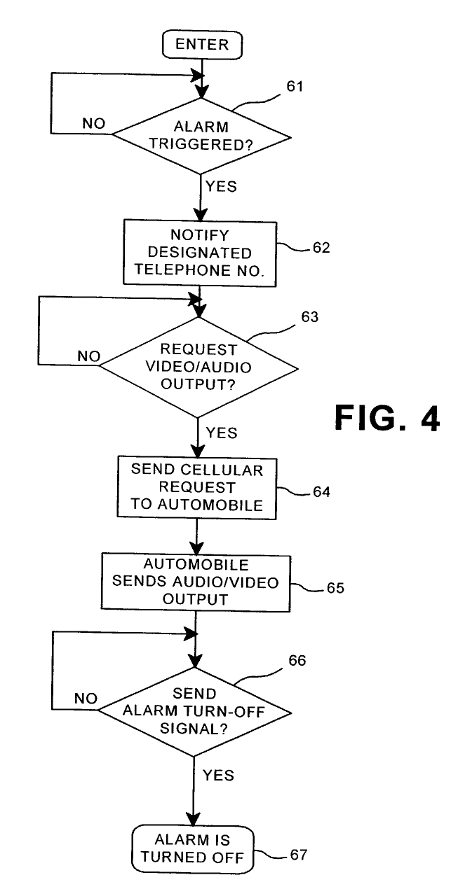

Now, with reference to the flowchart of FIG. 4, a simplified illustrative run of the process set up in FIG. 3 will be described. A determination is made as to whether the alarm has been triggered, step 61. If No, the triggering of the alarm continues to be monitored. If Yes, the alarm has been triggered, then the designated telephone number is notified, step 62. Next, a determination is made as to whether the user has requested a video or audio output, step 63. If No, such an indication is awaited. If Yes, then a request is made to the automobile over the cellular system for the video and/or audio sensor output, step 64, and the automobile sends such output to the user at the designated telephone number, step 65. After the user has had an opportunity to review the video/audio output, a determination is made as to whether the user has sent a signal to have the alarm turned off, step 66. If No, the alarm remains on. If Yes, the alarm may be remotely turned off by the user.

Although certain preferred embodiments have been shown and described, it will be understood that many changes and modifications may be made therein without departing from the scope and intent of the appended claims.

What is claimed is:

1. An automobile having incorporated therein an alarm system triggering a loud audio output upon detection of unauthorized entry into the automobile comprising:
a wireless telephonic device in said automobile, responsive to the triggering of said audio output, for sending a cellular telephonic message indicating the triggering of said output to a designated receiving telephone;
a cellular telephone network for transmitting said message; and
a device enabling a user to selectively designate the receiving telephone to which said telephonic message is to be sent.

2. The automobile alarm system of claim 1 wherein said receiving telephone is a mobile wireless cellular telephone.

3. The automobile alarm system of claim 2 wherein said wireless telephonic device in said automobile is adapted to receive cellular telephonic signals from said designated cellular telephone.

4. The automobile alarm system of claim 3 further including:
a device for sensing ambient conditions in said automobile; and
wherein said wireless telephonic device includes means for transmitting cellular telephonic signals indicative of said sensed ambient conditions to said designated cellular telephone.

5. The automobile alarm system of claim 4 further including a device in said automobile for turning said audio alarm output off in response to a received telephonic signal from said designated telephone.

6. The automobile alarm system of claim 4 wherein said device for sensing ambient conditions is a video device.

7. The automobile alarm system of claim 4 wherein said device for sensing ambient conditions is an audio listening device.

8. The automobile alarm system of claim 2 wherein said cellular telephone to which said telephonic message is sent is a cellular telephone pager.

9. In a wireless cellular telephone network, a method for controlling audio alarms in automobiles having wireless cellular telephonic devices comprising:
enabling a user to selectively designate a receiving telephone connected to said network to which a message is to be sent upon the triggering of said audio alarm;
monitoring for the triggering of said alarm; and
transmitting said message from the wireless cellular telephonic device in said automobile to said designated receiving telephone over said cellular telephone network in response to the triggering of said alarm.

10. The method for controlling automobile alarms of claim 9 wherein said receiving telephone is a mobile wireless cellular telephone.

11. The method for controlling automobile alarms of claim 10 wherein said wireless telephonic device in said automobile receives cellular telephonic signals from said designated cellular telephone.

12. The method for controlling automobile alarms of claim 10 further including the steps of:
sensing ambient conditions in said automobile; and
transmitting cellular telephonic signals indicative of said sensed ambient conditions from the wireless telephonic device in said automobile to said designated cellular telephone.

13. The method for controlling automobile alarms of claim 12 further including the step of turning said audio alarm output off in response to a received telephonic signal from said designated telephone.

14. The method for controlling automobile alarms of claim 12 wherein the ambient conditions sensed are visual conditions.

15. The method for controlling automobile alarms of claim 12 wherein the ambient conditions sensed are audio conditions.

16. A computer program having code recorded on a computer readable medium for controlling audio alarms in automobiles having wireless cellular telephonic devices in a cellular telephone network comprising:
means in said automobile, responsive to the triggering of said audio output, for sending a cellular telephonic message indicating the triggering of said output to a designated receiving telephone; and
means enabling a user to selectively designate the receiving telephone in said network to which said telephonic message is to be sent.

17. The computer program of claim 17 wherein said receiving telephone is a mobile wireless cellular telephone.

18. The computer program of claim 17 wherein said means in said automobile for sending said cellular telephonic message is adapted to receive cellular telephonic signals from said designated cellular telephone.

19. The computer program of claim 18 further including:
means for sensing ambient conditions in said automobile; and
wherein said wireless telephonic device includes means for transmitting cellular telephonic signals indicative of said sensed ambient conditions to said designated cellular telephone.

20. The computer program of claim 19 further including means in said automobile for turning said audio alarm output off in response to a received telephonic signal from said designated telephone.

21. The computer program of claim 19 wherein said means for sensing ambient conditions senses visual conditions.

22. The computer program of claim 19 wherein said means for sensing ambient conditions senses audio conditions.
